(19) United States
(12) Patent Application Publication
(10) Pub. No.: US 2007/0238026 A1
(43) Pub. Date: Oct. 11, 2007

(54) Holographic recording composition, optical recording medium and optical recording method

(75) Inventors: Satoru Yamada, Kanagawa (JP); Kazunori Nigorikawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,964

(22) Filed: Mar. 29, 2007

(30) Foreign Application Priority Data
Mar. 29, 2006 (JP) 2006-090641
Sep. 29, 2006 (JP) 2006-268361

(51) Int. Cl. G03H 1/04

(52) U.S. Cl. 430/1; 430/2; 359/3

(57) ABSTRACT

Provided is a holographic recording composition that comprises a monomer expressed by the Structural Formula (1) below:

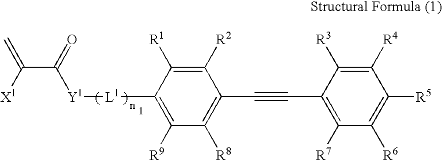

in the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group; n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom;

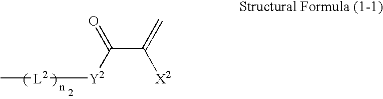

### BACKGROUND OF THE INVENTION

1. Field of the Invention

The present invention relates to holographic recording compositions, suited for producing therefrom volume holographic optical recording media, with larger recording-layer thicknesses in particular, to which information can be recorded and reproduced by use of laser light, and also optical recording media and methods that utilize the holographic recording compositions.

2. Description of the Related Art

Holographic optical recording media have been heretofore developed on the basis of holography. Information can be recorded onto the holographic optical recording media by way of overlapping lights having image information and reference lights in recording layers formed of photosensitive compositions, and writing the resulting interference stripes onto recording layers. On the other hand, information lights are reproduced by way of irradiating reference lights onto recording layers at certain angles and causing optical diffraction of the reference lights by action of the interference stripes.

Volume holography, in particular digital volume holography, has recently been developed in feasible regions and has been attracting attention with respect to the possibility of ultra high-density optical recording. In the volume holography, the optical recording media are utilized aggressively in their thickness direction as well and the interference stripes are three-dimensionally written, providing features that larger thicknesses lead to higher diffraction efficiencies and larger recording capacities by use of multiple recording. In the digital volume holography, the recording is carried out in the similar recording media/manners as volume holography except that the recording image information is exclusively binarized into digital patterns so as to adapt to computers. In the digital volume holography, for example, analog image information such as pictures is once digitized to represent as two-dimension digital pattern information, which is recorded as image information. Upon reproduction, the digital pattern information is read and decoded, thereby to express the original image information. These processes may make possible to reproduce extremely faithfully the original information, even when S/N ratio (ratio of signal to noise) is somewhat lower by virtue of derivative detection and/or correcting errors through coding the binarized data (Japanese Patent Application Laid-Open (JP-A) No. 11-311936).

These volume holographic optical recording media are demanded for larger recording density. In this concept, an optical recording medium is proposed that comprises a urethane matrix and a phenylacrylate derivative (JP-A No. 2005-502918). However, the proposed optical recording medium is insufficient in terms of the recording capacity, thus still more improvement has been desired.

In addition, a tran compound is proposed for a liquid crystal compound (JP-A Nos. 2005-292241 and 2005-281171). However, no disclosure or suggestion is included in these proposals with respect to application of a tran compound for a monomer into hologram materials of photopolymer systems.

### BRIEF SUMMARY OF THE INVENTION

The present invention aims to provide a holographic recording composition, which is adapted to digital volume holography with larger memory capacity, an optical recording medium, which contains the holographic recording composition and performs optical-recording with super-high density, and also an optical recording method thereof.

The holographic recording composition according to the present invention comprises a monomer expressed by Structural Formula (1) shown below as the recording monomer, therefore, information may be recorded at higher sensitivity, relatively inexpensive laser systems may be employed, and writing period may be shortened, thus the holographic recording composition according to the present invention may be favorably applied for digital volume holography with larger memory capacity.

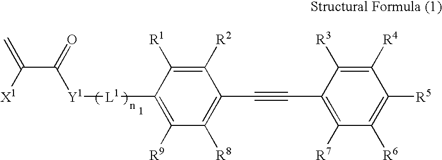

In the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group, n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; the R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom.

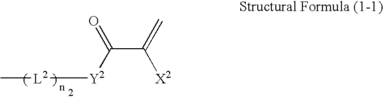

In the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

The optical recording medium according to the present invention comprises a holographic recording layer formed from the holographic recording composition according to the present invention, thus the optical recording can be of super-high density, which hence making the inventive optical recording medium significantly appropriate for recording media of digital volume holography.

### BRIEF DESCRIPTION OF THE SEVERAL VIEWS OF THE DRAWINGS

FIG. 1 is a schematic cross section that exemplarily shows an optical recording medium of the first embodiment according to the present invention.

FIG. 2 is a schematic cross section that exemplarily shows an optical recording medium of the second embodiment according to the present invention.

FIG. 3 is an exemplary view that explains an optical system around the inventive optical recording medium.

FIG. 4 is a block diagram that shows exemplarily an entire construction of an optical recording/reproducing apparatus equipped with an optical recording medium according to the present invention.

### DETAILED DESCRIPTION OF THE INVENTION

Holographic Recording Composition

The holographic recording composition according to the present invention comprises a monomer expressed by the Structural Formula (1) shown below, and also other optional ingredients such as a matrix and a photopolymerization initiator.

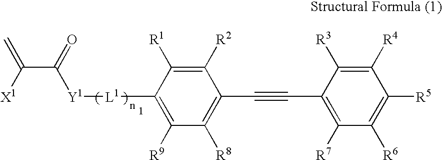

In the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group; n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom.

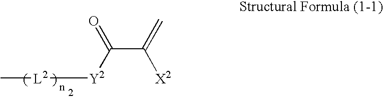

In the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

Monomer Expressed by Structural Formula (1)

The “monomer” described above refers to compounds that can undergo polymerization through a photopolymerization initiator in relation to information recording. The polymerization may be radical or cation polymerization, preferably is radical polymerization.

In the Structural Formula (1), X¹ represents a hydrogen atom (H) or a methyl group, preferably a hydrogen atom. In the Structural Formula (1), Y¹ represents an oxygen atom (O) or NR¹⁰ (R¹⁰ represents a hydrogen atom or an alkyl group), preferably an oxygen atom (O).

In the Structural Formula (1), R¹ and R², R³ and R⁴, R⁴ and R⁵, R⁵ and R⁶, R⁶ and R⁷, or R⁸ and R⁹ may form a ring structure together with at least an adjacent carbon atom. The ring structure may be saturated hydrocarbon rings or unsaturated hydrocarbon rings such as benzene ring, particularly preferably condensed ring structures of benzene ring.

In the Structural Formula (1), L¹ represents a divalent organic connecting group; examples thereof include —O—, —S—, —C(═O)—, —NH—, an alkylene group, oxyalkylene group, arylene group, oxyarylene group, aminoalkylene group, aminoarylene group, and combinations thereof. Among these, the divalent organic connecting group is preferably an alkylene group, oxyalkylene group, arylene group, oxyarylene group, aminoalkylene group and aminoarylene group, particularly preferable is an alkylene group and oxyalkylene group.

The divalent organic connecting group may be branched or have a substituent; preferably, has a carbon number of 1 to 30, more preferably 1 to 20, particularly preferably 1 to 10. The substituent may be those described above, provided that when the terminal of the divalent organic connecting group is a hetero atom, the hetero atom binds to the benzene ring rather than Y¹.

Specific examples of the divalent organic connecting group are shown in the following, but not limited to.

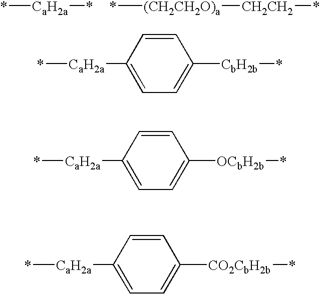

In the formulas described above, * represents a bonding site with Y¹, “a” is an integer of 1 to 20, and “b” is an integer of 1 to 20.

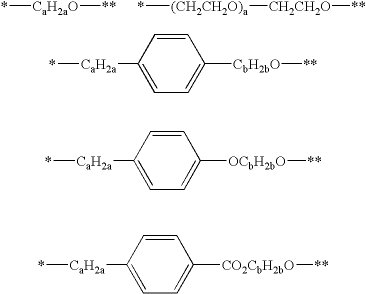

In the formulas described above, * represents a bonding site with Y¹, ** represents a bonding site with a benzene ring, “a” is an integer of 1 to 20, and “b” is an integer of 1 to 20.

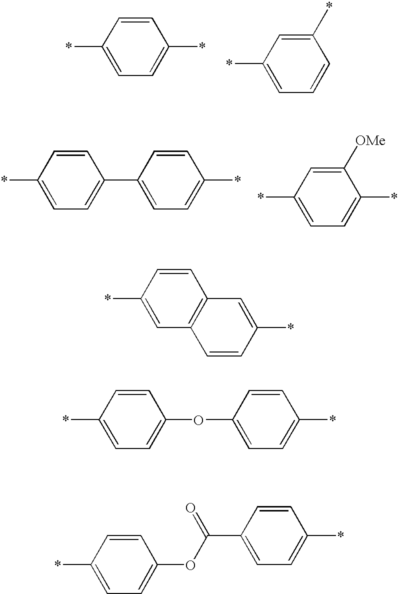

In the formulas described above, * represents a bonding site with Y¹, and Me represents a methyl group.

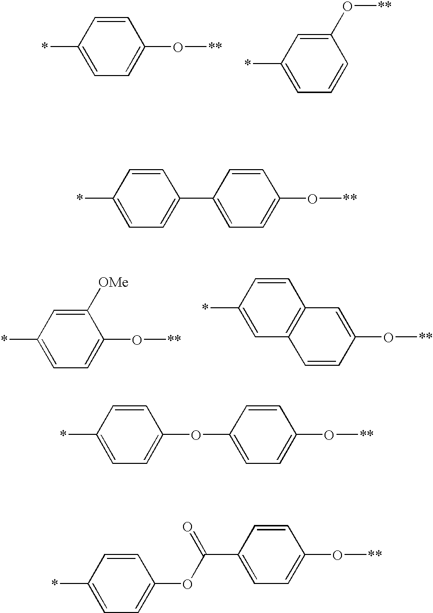

In the formulas described above, * represents a bonding site with Y¹, ** represents a bonding site with a benzene ring, and Me represents a methyl group.

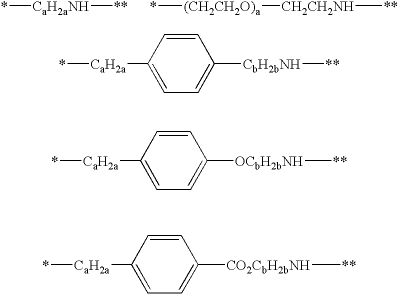

In the formulas described above, * represents a bonding site with Y¹, ** represents a bonding site with a benzene ring, “a” is an integer of 1 to 20, and “b” is an integer of 1 to 20.

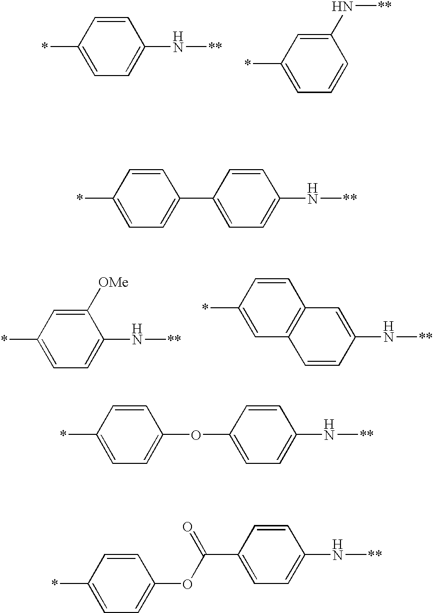

In the formulas described above, * represents a bonding site with Y¹, and ** represents a bonding site with a benzene ring.

In the Structural Formula (1), n₁ is an integer of 0 or 1, preferably 1 in view of solubility.

In the Structural Formula (1) shown above, R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; the R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom.

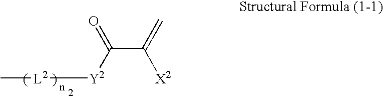

In the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

It is preferred, in the Structural Formula (1), that the alkyl groups expressed by R¹ to R¹⁰ each has a carbon number of 1 to 20, more preferably 1 to 10, still more preferably 1 to 5. Examples of these alkyl groups include a methyl group, ethyl group, n-propyl group, isopropyl group, n-butyl group, isobutyl group, tert-butyl group, pentyl group, cyclopentyl group, hexyl group, cyclohexyl group, heptyl group, octyl group, tert-octyl group, 2-ethylhexyl group, decyl group, dodecyl group, and octadecyl group. These alkyl groups may be further substituted by a substituent.

It is preferred, in the Structural Formula (1), that the halogen atom expressed by R¹ to R¹⁰ may be iodine, bromine, chlorine or fluorine atom, preferably iodine or bromine atom.

It is preferred, in the Structural Formula (1), that the heterocyclic groups expressed by R¹ to R⁹ each has a carbon number of 4 to 12, more preferably 4 or 5. Examples of the heterocyclic groups include a pyridine ring group, pyrrole ring group, thiophene ring group, and pyrimidine ring group. These heterocyclic groups may be further substituted by a substituent.

It is preferred, in the Structural Formula (1), that the alkoxy groups expressed by R¹ to R⁹ each has a carbon number of 1 to 20, more preferably 1 to 10, particularly preferably 1 to 5. Examples of the alkoxy groups include a methoxy group, ethoxy group, butoxy group, propyoxy group, hexyloxy group, cyclohexyloxy group, heptyloxy group, octyloxy group, tert-octyloxy group, 2-ethylhexyloxy group, decyloxy group, dodecyloxy group, and octadecyloxy group. These alkoxy groups may be further substituted by a substituent.

It is preferred, in the Structural Formula (1), that the aryl groups expressed by R¹ to R⁹ each has a carbon number of 6 to 14, more preferably 6 to 10, particularly preferably 6. Examples of the aryl group include a phenyl group, naphthyl group and anthranil group. These aryl groups may be further substituted by a substituent.

It is preferred, in the Structural Formula (1), that the aryloxy groups expressed by R¹ to R⁹ each has a carbon number of 6 to 12, more preferably 6. Examples of the aryloxy group include a phenyloxy group, naphthyloxy group and anthraniloxy group. These aryloxy groups may be further substituted by a substituent.

It is preferred, in the Structural Formula (1), that the alkoxycarbonyl groups expressed by R¹ to R⁹ each has a carbon number of 1 to 10, more preferably 1 to 7, particularly preferably 1 to 5. Examples of the alkoxycarbonyl groups include a methoxycarbonyl group, ethoxycarbonyl group, butoxycarbonyl group, propyoxycarbonyl group, hexyloxycarbonyl group, cyclohexyloxycarbonyl group, heptyloxycarbonyl group, octyloxycarbonyl group, tert-octyloxycarbonyl group, and 2-ethylhexyloxycarbonyl group. These alkoxycarbonyl groups may be further substituted by a substituent.

It is preferred, in the Structural Formula (1), that the aryloxycarbonyl groups expressed by R¹ to R⁹ each has a carbon number of 6 to 12, more preferably 6. Examples of the aryloxycarbonyl group include a phenyloxycarbonyl group, naphthyloxycarbonyl group and anthraniloxycarbonyl group. These aryloxycarbonyl groups may be further substituted by a substituent.

It is preferred, in the Structural Formula (1), that the carbamoyl groups expressed by R¹ to R⁹ each has a carbon number of 1 to 12, more preferably 1 to 6. Examples of the carbamoyl groups include a methylcarbamoyl group, ethylcarbamoyl group, n-propylcarbamoyl group, isopropylcarbamoyl group, n-butylcarbamoyl group, isobutylcarbamoyl group, tert-butylcarbamoyl group, and phenylcarbamoyl group. These carbamoyl groups may be further substituted by a substituent.

It is preferred, in the Structural Formula (1), that the sulfamoyl groups expressed by R¹ to R⁹ each has a carbon number of 1 to 12, more preferably 1 to 6. Examples of the sulfamoyl groups include a methylsulfamoyl group, ethylsulfamoyl group, n-propylsulfamoyl group, isopropylsulfamoyl group, n-butylsulfamoyl group, isobutylsulfamoyl group, tert-butylsulfamoyl group, and phenylsulfamoyl group. These sulfamoyl groups may be further substituted by a substituent.

It is preferred, in the Structural Formula (1), that the amino groups expressed by R¹ to R⁹ each has a carbon number of 1 to 12, more preferably 1 to 6. The amino groups may be mono-substituted or di-substituted. Examples of the amino groups include a methylamino group, dimethylamino group, ethylamino group, diethylamino group, n-propylamino group, isopropylamino group, n-butylamino group, isobutylamino group, tert-butylamino group, phenylamino group, and diphenylamino group. These amino groups may be further substituted by a substituent.

It is preferred, in the Structural Formula (1), that the acyloxy groups expressed by R¹ to R⁹ each has a carbon number of 1 to 12, more preferably 1 to 6. Examples of the acyloxy groups include a methylcarbonyloxy group, ethylcarbonyloxy group, n-propylcarbonyloxy group, isopropylcarbonyloxy group, n-butylcarbonyloxy group, isobutylcarbonyloxy group, tert-butylcarbonyloxy group, phenylcarbonyloxy group, and acryloyloxy group. These acyloxy groups may be further substituted by a substituent.

It is preferred, in the Structural Formula (1), that the acylamino groups expressed by R¹ to R⁹ each has a carbon number of 1 to 12, more preferably 1 to 6. Examples of the acylamino groups include a methylcarbonylamino group, ethylcarbonylamino group, n-propylcarbonylamino group, isopropylcarbonylamino group, n-butylcarbonylamino group, isobutylcarbonylamino group, tert-butylcarbonylamino, phenylcarbonylamino group, and acryloylamino group. These acylamino groups may be further substituted by a substituent.

X², Y², L², and n₂, in the Structural Formula (1-1) that expresses R¹ to R⁹ in the Structural Formula (1), may be identical or different with, and preferably are identical with X¹, Y¹, L¹, and n₁ in the Structural Formula (1), preferably identical.

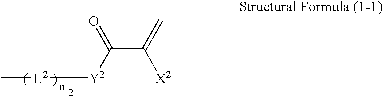

In the Structural Formula (1-1), X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

Examples of the substituents, by which the R¹ to R⁹ may be further substituted, include an alkyl group, phenyl group, halogen atom, alkoxy group, aryloxy group, alkoxycarbonyl group, aryloxycarbonyl group, acyloxy group, acylamino group, carbamoyl group, sulfamoyl group, cyano group, carboxylic acid group, hydroxyl group, sulfonic acid group, and heterocycle group; among these substituents, preferable are a phenyl group, halogen atom, alkoxy group, aryloxy group, alkoxycarbonyl group, aryloxycarbonyl group, acyloxy group, acylamino group, carbamoyl group, cyano group, and heterocycle group; more preferable are a phenyl group, halogen atom, alkoxy group, aryloxy group, alkoxycarbonyl group, acyloxy group, and acylamino group; particularly preferable are a phenyl group, halogen atom, alkoxy group, aryloxy group, and alkoxycarbonyl group.

The monomers, expressed by the Structural Formula (1), are a multifunctional compound provided that a terminal of R¹ to R⁹ groups is substituted by an acyloxy group and the acyloxy group is an acryloyloxy, methacryloyloxy, acryloylamino, or methacryloylamino group. It is preferred among these that the terminal is substituted by an acryloyloxy or acryloylamino group to form a multifunctional compound in particular from the viewpoint of appropriate recording retainment.

It is preferred, in the Structural Formula (1), that R¹, R², R³, R⁴, R⁶, R⁷, R⁸, and R⁹ are each a hydrogen atom; X¹ is a hydrogen atom or a methyl group; Y¹ is an oxygen atom or NR¹⁰ (R¹⁰ represents a hydrogen atom or an alkyl group); L¹ is an oxyalkylene group; n₁ is 1; R⁵ is an alkyl group that may have a substituent, an alkoxy group that may have a substituent, an aryloxycarbonyl group that may have a substituent, or a substituent expressed by the Structural Formula (1-1). It is most preferable that that R¹, R², R³, R⁴, R⁶, R⁷, R⁸, and R⁹ are each a hydrogen atom; X¹ is a hydrogen atom; Y¹ is an oxygen atom (O); L¹ is an oxyalkylene group; n₁ is 1; R⁵ is an alkyl group that may have a substituent.

Specific examples of the monomers expressed by the Structural Formula (1) are shown in the following, but not limited to. These monomers may be used alone or in combination of two or more.

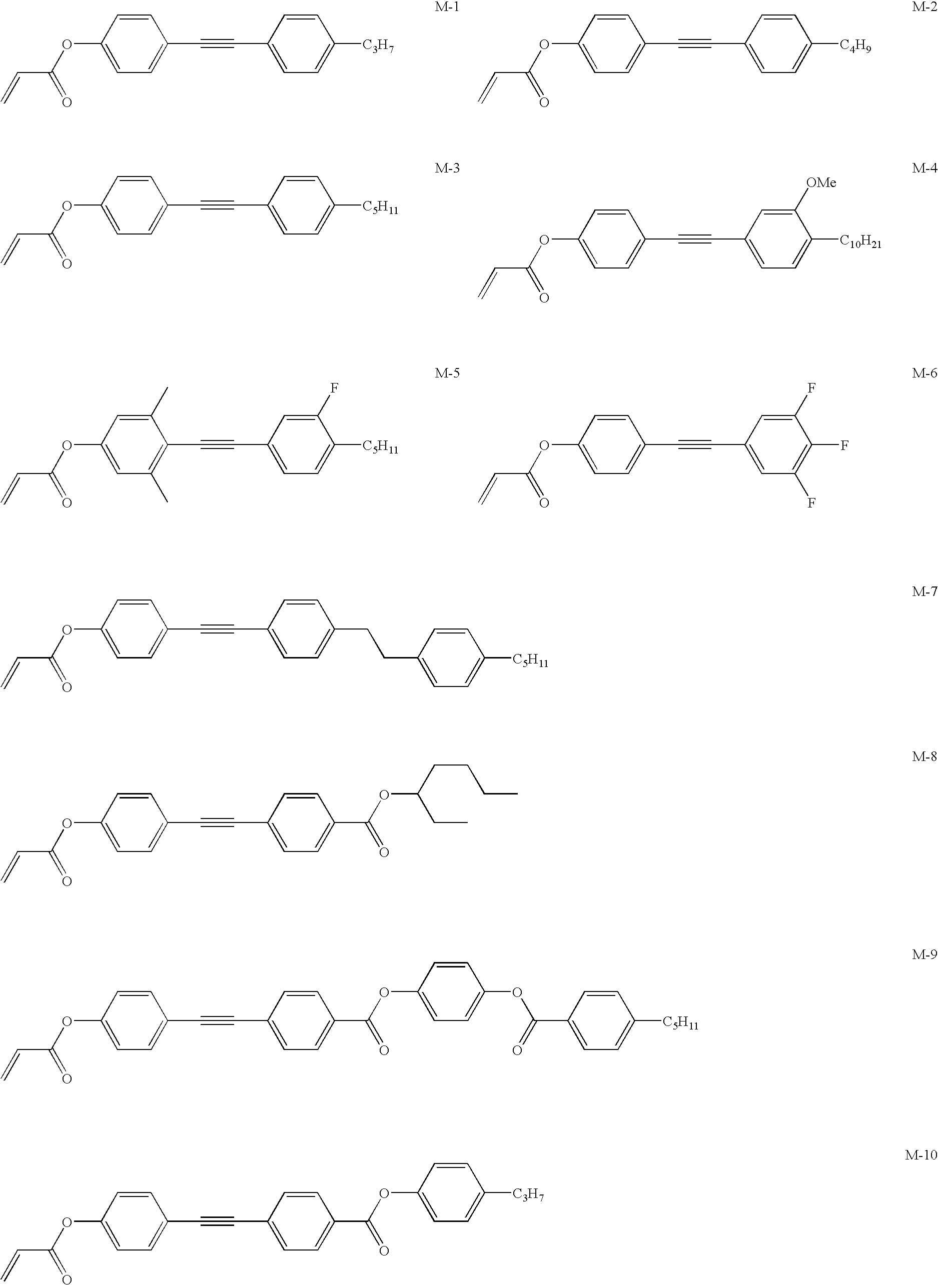

In the structural formulas above, Me represents a methyl group.

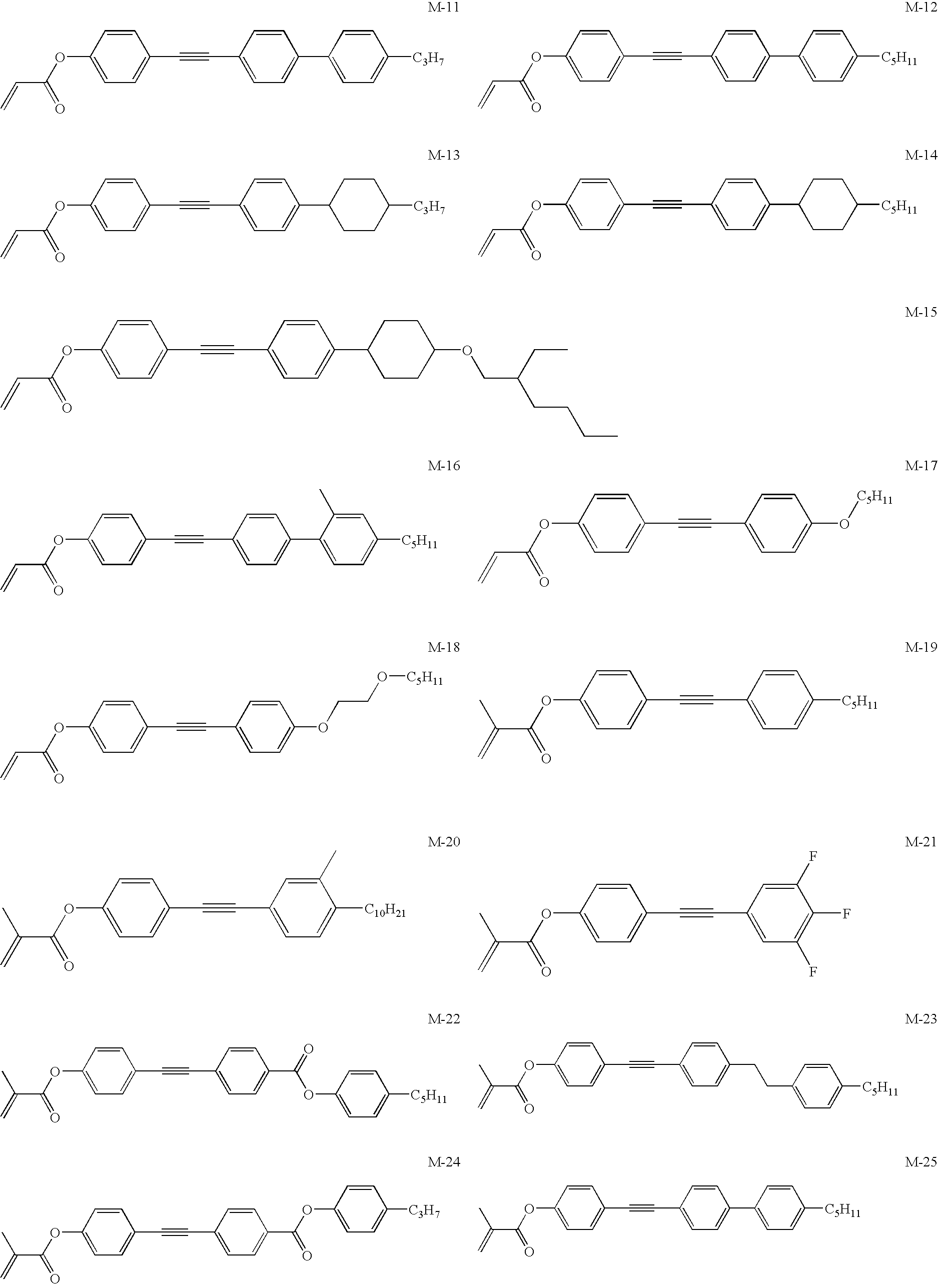

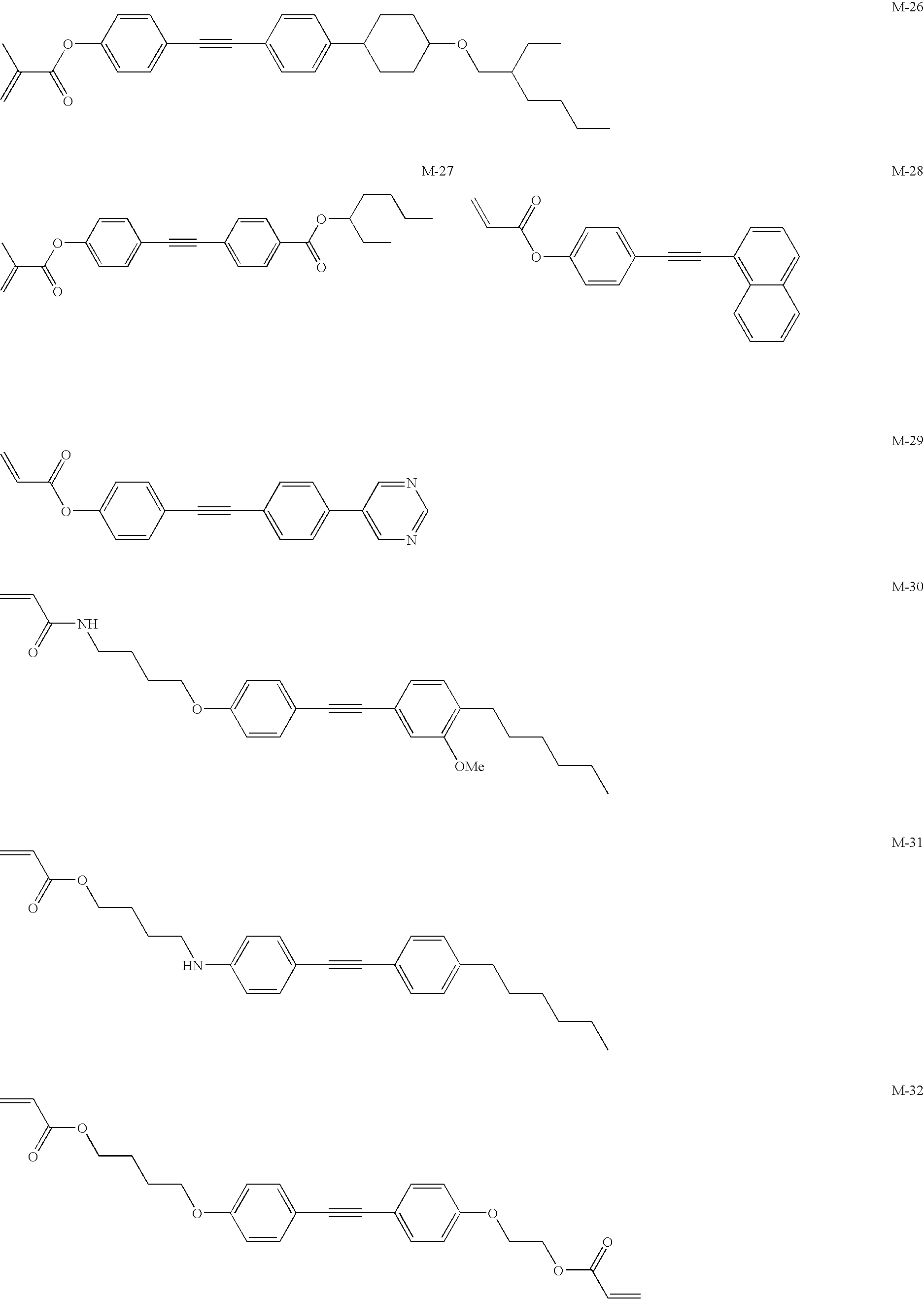

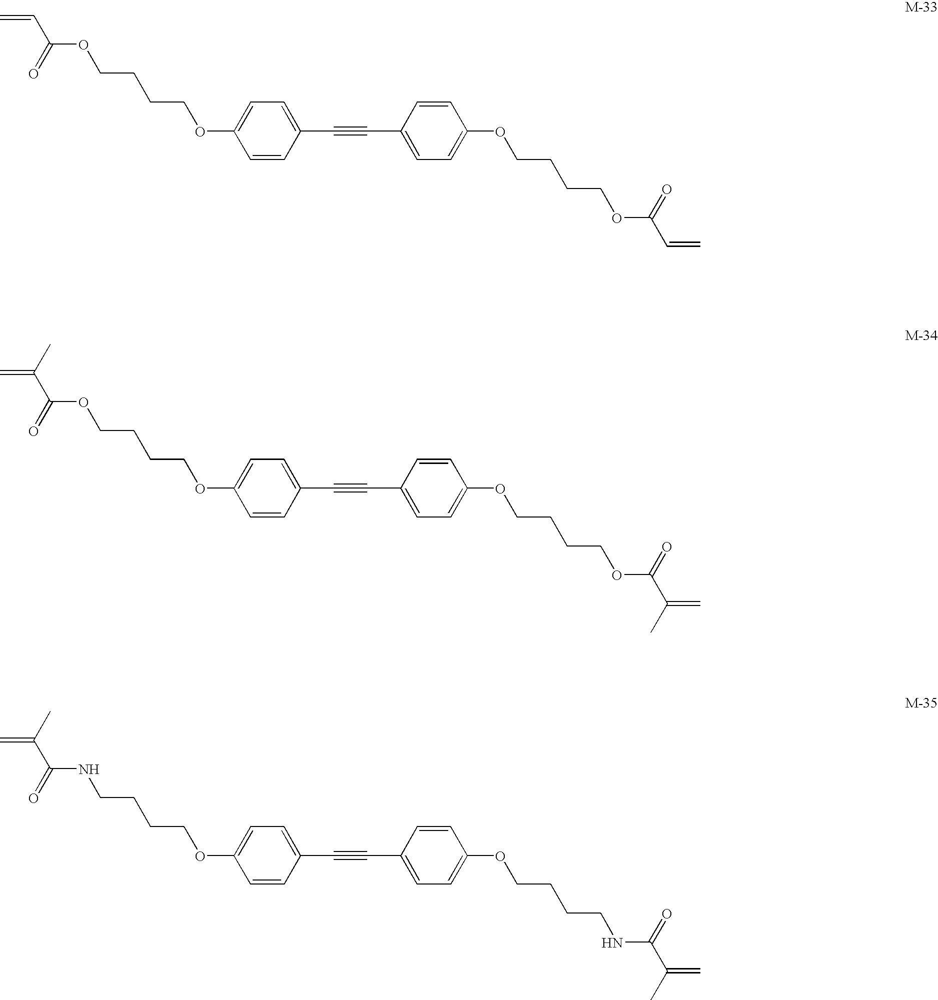

In the structural formulas above, Me represents a methyl group. 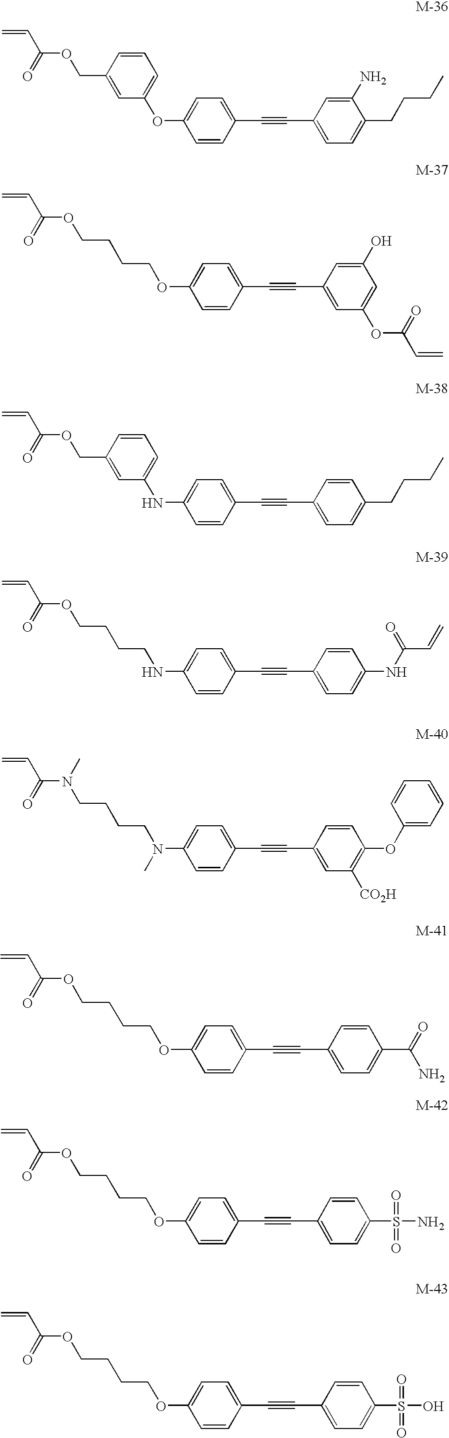
Synthetic Process of Monomer Expressed by Structural Formula (1)

The monomers expressed by the Structural Formula (1) may be synthesized as follows; specific examples of synthetic processes are shown in the following in terms of above-noted M-32 and M33.

Synthesis of M-32

T-1 (synthetic product) expressed by the structural formula below is dissolved in an amount of 7.0 g into 300 mL of acetonitrile, to which then 1.8 g of triethylamine (by Tokyo Chemical Industry Co.) is added dropwise. After cooling the solution to 0° C., 1.66 g of acrylyl chloride (by Tokyo Chemical Industry Co.) is added dropwise. After mixing four hours, 500 mL of ethyl acetate and 500 mL of water are added to the mixture to extract an organic layer, then which is concentrated. The resulting material is treated with silica gel chromatography (hexane/ethyl acetate=1/1 of vol/vol), thereby to prepare the compound (M-32) expressed by the formula below. 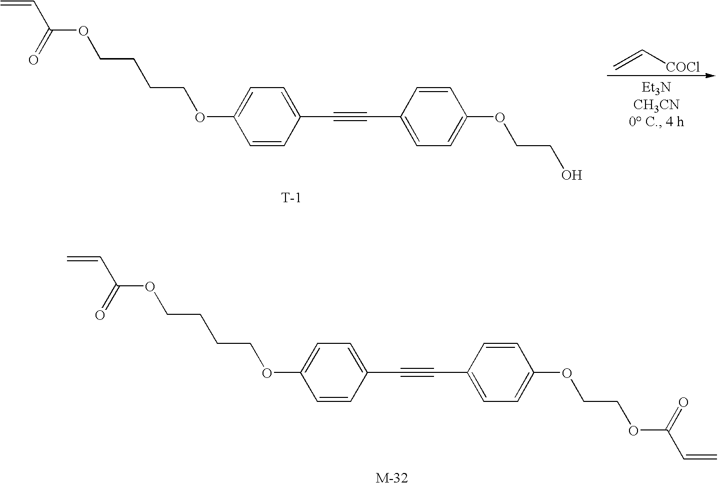
Synthesis of M-33

T-2 (synthetic product) expressed by the structural formula below is dissolved in an amount of 2.1 g into 200 mL of N,N-dimethylacetamide (by Tokyo Chemical Industry Co.), to which then 2.8 g potassium carbonate (by Tokyo Chemical Industry Co.) is added. T-3 (synthetic product) expressed by the structural formula below is added in an amount of 5.8 g and the mixture is stirred at 90° C. for 4 hours, followed by adding 500 mL of ethyl acetate and 500 mL of water, then an organic layer is extracted and concentrated. The resulting material is treated with silica gel chromatography (hexane/ethyl acetate=1/1 of vol/vol), thereby to prepare the compound (M-33) expressed by the formula below.

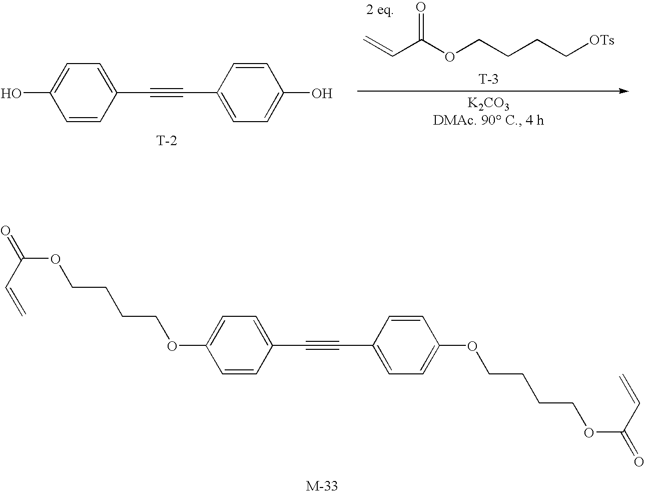

The monomer expressed by the Structural Formula (1) may be used together with other monomers as required. The other monomers may be properly selected depending on the application, for example, from radical-polymerizable monomers having an unsaturated bond such as of acrylic and methacrylic group. These polymers may be monofunctional or polyfunctional.

Examples of the radical-polymerizable monomers include acryloyl morpholine, phenoxyethylacrylate, isobornylacrylate, 2-hydroxypropylacrylate, 2-ethylhexylacrylate, 1,6-hexanediol diacrylate, tripropyleneglycol diacrylate, neopentylglycol PO-modified diacrylate, 1,9-nonandiol diacrylate, hydroxylpivalic acid neopentylglycoldiacrylate, EO-modified bisphenol A diacrylate, polyethyleneglycol diacrylate, pentaerythritol triacrylate, pentaerythritol tetraacrylate, pentaerythritol hexaacrylate, EO-modified glycerol triacrylate, trimethylolpropane triacrylate, EO-modified trimethylolpropane triacrylate, 2-naphtho-1-oxyethylacrylate, 2-carbazoyl-9-ylethylacrylate, (trimethylsilyloxy)dimethylsilyl propylacrylate, vinyl-1-naphthoate, N-vinylcarbazol, 2,4,6-tribromophenylacrylate, pentabromoacrylate, phenylthioethylacrylate and tetrahydrofurfurylacrylate.

The content of the monomer in the holographic recording composition may be properly selected depending on the application; preferably, the content is 1 to 50% by mass, more preferably 1 to 30% by mass, still more preferably 3 to 10% by mass. In cases where the content is above 50% by mass, it may be difficult to take stably interference images, and in cases where the content is below 1% by mass, desirable quality may unavailable in view of diffraction efficiency.

Analytical Method for Monomer Expressed by Structural Formula (1)

The monomers expressed by the Structural Formula (1) may be detected by way of extracting recording layers of optical recording media, which containing a recording layer formed from a holographic recording composition according to the present invention in the recording layer, using a solvent of tetrahydrofuran (THF) or dioxane, then the eluent is analyzed by liquid chromatography (HPLC).

Matrix

The matrix refers to polymers to hold or sustain monomers, available in recording and/or preservation, and photopolymerization initiators. The matrix is employed to improve film-coating property, to enhance film strength and/or to upgrade hologram recording properties. The matrix may be heat-cured or photo-cured with aid of catalysts.

The matrix may be properly selected depending on the application, preferably is thermosetting ones. Specific examples of the matrix are urethane matrixes formed from polyfunctional isocyanates and polyfunctional alcohols; polymers formed from epoxy compounds derived from oxirane compounds, melamine compounds, formalin compounds, ester compounds such as of (meth)acrylic acid and itaconic acid, and/or amido compounds. Among these, particularly preferable are urethane matrixes formed from polyfunctional isocyanates and polyfunctional alcohols.

The polyfunctional isocyanate may be of lower or higher molecular weight. The isocyanate may be used alone or in combination of two or more.

Examples of the polyfunctional isocyanate include biscyclohexyl methanediisocyanate, hexamethylene diisocyanate, phenylene-1,3-diisocyanate, phenylene-1,4-diisocyanate, 1-methoxyphenylene-2,4-diisocyanate, 1-methylphenylene-2,4-diisocyanate, 2,4-thrylenediisocyanate, 2,6-thrylenediisocyanate, 1,3-xylylenediisocyanate, 1,4-xylylenediisocyanate, biphenylene-4,4′-diisocyanate, 3,3′-dimethoxybiphenylene-4,4′-diisocyanate, 3,3′-dimethylbiphenylene-4,4′-diisocyanate, diphenylmethane-2,4′-diisocyanate, diphenylmethane-4,4′-diisocyanate, 3,3′-dimethoxydiphenylmethane-4,4′-diisocyanate, 3,3′-dimethyldiphenylmethane-4,4′-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatemethylcyclohexane, cyclohexane-1,3-bis(methylisocyanate), cyclohexane-1,4-bis(methylisocyanate), isophoronediisocyanate, dicyclohexylmethane-2,4′-diisocyanate, dicyclohexylmethane-4,4′-diisocyanate, ethylenediisocyanate, tetramethylene-1,4-diisocyanate, hexamethylene-1,6-diisocyanate, dodecamethylene-1,12-diisocyanate, phenyl-1,3,5-triisocyanate, diphenylmethane-2,4,4′-triisocyanate, diphenylmethane-2,5,4′-triisocyanate, triphenylmethane-2,4′,4″-triisocyanate, triphenylmethane-4,4′,4″-triisocyanate, diphenylmethane-2,4,2′,4′-tetraisocyanate, diphenylmethane-2,5,2′,5′-tetraisocyanate, cyclohexane-1,3,5-triisocyanate, cyclohexane-1,3,5-tris(methylisocyanate), 3,5-dimethylcyclohexane-1,3,5-tris(methylisocyanate), 1,3,5-trimethylcyclohexane-1,3,5-tris(methylisocyanate), dicyclohexylmethane-2,4,2′-triisocyanate and dicyclohexylmethane-2,4,4′-triisocyanatelysine diisocyanatemethylester, and also prepolymers having isocyanates at both ends that are prepared by reaction between these organic isocyanate compounds of over stoichiometric quantities and polyfunctional compounds containing an active hydrogen. The polyfunctional alcohols may be of lower or higher molecular-weight. These polyfunctional alcohols may be used alone or in combination of two or more.

Polyfunctional Alcohol

Examples of the polyfunctional alcohols include glycols such as ethylene glycol, diethylene glycol, triethylene glycol, polyethylene glycol, propylene glycol, polypropylene glycol and neopentyl glycol; diols such as butanediols, pentanediols, hexanediols, heptanediols and alkane diols with a carbon number of two more; triols such as butanetriol, pentanetriol, hexanetriol and decanetriol; polyphenols such as catechol and resorcinol; bisphenols; and these polyfunctional compounds modified with polyethyleneoxy chains.

The content of the matrix is preferably 10 to 95% by mass in the holographic recording composition, more preferably 35 to 90% by mass. The content of below 10% by mass may render difficult to generate stable interference images, and in cases of above 95% by mass, desirable quality may unavailable in view of diffraction efficiency.

Photopolymerization Initiator

The photopolymerization initiator may be selected from those sensitive to recording lights, for example, from substances capable of inducing a radical polymerization reaction.

Examples of the photopolymerization initiator include 2,2′-bis(o-chlorophenyl)-4,4′,5,5′-tetraphenyl-1,1′-biimidazole, 2,4,6-tris(trichloromethyl)-1,3,5-triazine, 2,4-bis(trichloromethyl)-6-(p-methoxyphenylvinyl)-1,3,5-triazine, diphenyliodoniumtetrafluoroborate, diphenyliodoniumhexafluorophosphate, 4,4′-di-t-butyldiphenyliodoniumtetrafluoroborate, 4-diethylaminophenylbenzenediazonium hexafluorophosphate, benzoin, 2-hydroxy-2-methyl-1-phenylpropane-2-one, benzophenone, thioxanthone, 2,4,6-trimethylbenzoyldiphenylacyl phosphineoxide, triphenylbutylborate tetraethylammonium, bis(η5-2,4-cyclopentadiene-1-yl), bis[2,6-difluoro-3-(1H-pyrrole-1-yl)phenyltitanium], and diphenyl-4-phenylthiophenylsulfonium hexafluorophosphate. These may be used alone or in combination of two or more. The sensitizing dyes described later may also be added so as to adapt with irradiating wavelengths.

Preferably, the content of the photopolymerization initiator is 0.01% by mass to 5% by mass in the holographic recording composition, more preferably 1% by mass to 3% by mass.

Other Ingredients

The other ingredients described above may be polymerization inhibitors or antioxidants for improving the preservation stability of the holographic recording composition.

The polymerization inhibitor or antioxidant may be, for example, hydroquinone, p-benzoquinone, hydroquinone monomethylether, 2,6-di-tert-butyl-p-cresol, 2,2′-methylenebis(4-methyl-6-tert-butylphenol), triphenylphosphite, trisnonyl phenylphosphite, phenothiazine or N-isopropyl-N′-phenyl-p-phenylene diamine.

The content of the polymerization inhibitor or antioxidant described above is no more than 3% by mass based on the total mass of the monomers. In cases where the content is more than 3% by mass, the polymerization tends to delay or cease in some cases.

The holographic recording compositions may be added with sensitizing dyes as required. The sensitizing dyes may be conventional compounds described in “Research Disclosure, vol. 200, December 1980, Item 20036” or “Sensitizer, pp. 160-163, Kodansha Ltd., ed. Katsumi Tokumaru and Shin Ohgawara, 1987.”

Specific examples of the sensitizing agents are 3-ketocoumarin compounds described in JP-A No. 58-15603; thiopyrylium salts described in JP-A No. 58-40302; naphthothiazole merocyanine compounds described in Japanese Patent Application Publication (JP-B) Nos. 59-28328 and 60-53300; and merocyanine compounds described in JPB Nos. 61-9621 and 62-3842, JP-A Nos. 59-89303 and 60-60104.

Furthermore, the sensitizing agents may be the dyes described in “Functional Dye Chemistry, 1981, CMC Publishing Co., pp. 393-416” or “Color Material, 60 (4), 212-224 (1987)”; more specific are cationic methine dyes, cationic carbonium dyes, cationic quinonimine dyes, cationic indoline dyes and cationic styryl dyes.

Still furthermore, the sensitizing agents may keto dyes such as coumarin dyes including ketocoumarin and sulfocoumarin, merostyryl dyes, oxonol dyes and hemioxonol dyes; non-keto dyes such as non-keto polymethine dyes, triarylmethane dyes, xanthen dyes, anthracene dyes, rhodamine dyes, acridine dyes, aniline dyes and azo dyes; non-keto polymethine dyes such as azomethine dyes, cyanine dyes, carbocyanine dyes, dicarbocyanine dyes, tricarbocyanine dyes, hemicyanine dyes and styryl dyes; and quinonimine dyes such as azine dyes, oxazin dyes, thiazin dyes, quinoline dyes and thiazole dyes. The sensitizing agents may be used alone or in combination of two or more.

The holographic recording compositions may be added with photothermal conversion materials so as to enhance the sensitivity of recording layers formed from the holographic recording compositions.

The photothermal conversion materials may be properly selected depending on the intended performance or capability; the materials are preferably organic dyes from the viewpoint that the materials may be conveniently included into recording layers along with photopolymers and incident lights may be far from scattering, in addition the materials are preferably infrared-ray absorbing dyes from the viewpoint that the recording lights may be far from absorption and/or scattering.

The infrared-ray absorbing dyes may be properly selected depending on the application; preferably, the dyes are cationic dyes, complex-salt forming dyes and quinone neutral dyes. The maximum absorption wavelength of the infrared-ray absorbing dyes is preferably 600 nm to 1000 nm, particularly preferable is 700 nm to 900 nm.

The content of the infrared-ray absorbing dyes may be determined depending on the absorbance at infrared region of the resulting recording materials; preferably the absorbance is 0.1 to 2.5, more preferably 0.2 to 2.0.

Furthermore, in order to mitigate the volume change at polymerization, the holographic recording compositions may be added with an ingredient that can diffuse into the inverse direction with that of polymerizable ingredients, or compounds having an acid cleavage configuration may be added in addition to the polymers as required.

The holographic recording composition according to the present invention may be variously applied for recording information through irradiating lights that involve the information, particularly preferably is utilized as a volume holographic recording composition.

In cases where the holographic recording composition is of lower viscosity below a level, which hence making possible to form a recording layer from the composition by a casting process; on the other hand, when the viscosity is excessively higher for the casting process, the holographic recording composition is laid on a lower substrate, then an upper substrate is pressed onto the holographic recording composition similarly as lidding the upper substrate onto the holographic recording composition to form a recording layer, thereby to form a recording medium.

Optical Recording Medium

The inventive optical recording medium comprises a holographic recording layer formed from the inventive holographic recording composition, and also preferably comprises a first substrate, filter layer, holographic recording layer, second substrate, and also a reflective film, first gap layer, second gap layer and other layers as required. The first or the second substrate is sometimes referred to as upper or lower substrate respectively.

The optical recording medium described above may be properly selected as long as capable of recording and reproducing on the basis of hologram, for example, may be of relatively thin plane holograms to record two-dimensional information or volume holograms to record numerous information such as stereo images, alternatively of transmissive or reflective type. The recording mode of the hologram may be, for example, of amplitude hologram, phase hologram, brazed hologram or complex amplitude hologram. Among these, so-called Collinear system is preferable in particular in which an informing light and a reference light are irradiated as a coaxial light beam, and information is recorded on the recording region by an interference pattern generated by the interference between the informing light and the reference light.

First and Second Substrates

The substrate may be properly selected depending on the application as for the shape, configuration, size etc.; the shape may be disc-like, card-like etc.; the material is required for the mechanical strength in terms of the hologram recording media. In the case that the light for recording or reproducing is directed through the substrate, it is necessary that the substrate is sufficiently transparent at the wavelength region of the employed light.

The material of the substrate is usually selected from glasses, ceramics, resins etc.; preferably, resins are employed in particular from the view point of formability and cost.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics and costs. The substrate may be properly prepared or commercially available.

Plural address-servo areas, i.e. addressing areas linearly extending in the radial direction of the substrate, are provided on the substrate at a given angle to one another, and each sector-form area between adjacent address-servo areas serves as a data area. In the address-servo areas, information for a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits may be used as the information for tracking servo. The servo pit pattern is not necessarily required in the case that the optical recording medium is card-like shape.

The thickness of the substrate may be properly selected depending on the application; the thickness is preferably 0.1 to 5 mm, more preferably 0.3 to 2 mm. When the thickness of the substrate is less than 0.1 mm, the optical disc may be deformed during its storage; and when the thickness is more than 5 mm, the weight of the optical disc may be as heavy as excessively loading on the drive motor.

Recording Layer

Information can be recorded onto the recording layer, which being formed from the holographic recording composition, by use of holography.

The thickness of the recording layer may be properly selected depending on the application; the thickness is preferably 1 μm to 1,000 μm, more preferably 100 μm to 700 μm. When the thickness of the recording layer is within the preferable range, the sufficient S/N ratio may be attained even on the shift multiplex of 10 to 300; and the more preferable range may advantageously lead to more significant effect thereof.

Reflective Film

The reflective film is formed on the surface of the servo pit pattern of the substrate. As for the material of the reflective film, such material is preferable that provides the recording light and the reference light with high reflectivity. When the wavelength of light is 400 to 780 nm, Al, Al alloys, Ag, Ag alloys and the like are preferably used. When the wavelength of light is 650 nm or more, Al, Al alloys, Ag. Ag alloys, Au, Cu alloys, TiN and the like are preferably used.

By use of DVD (digital video disc), for example, as the optical recording medium capable of reflecting the light and also recording and erasing information, such directory information can be recorded and erased without adversely affecting holograms as those indicative of the locations where information being recorded, the time when the information being recorded, and the locations where errors being occurred and exchanged.

The process for forming the reflective film may be properly selected depending on the application; examples thereof include various types of vapor deposition, such as vacuum vapor deposition, sputtering, plasma CVD, photo CVD, ion plating, and electron beam vapor deposition. Among these, sputtering is most preferable in view of mass productivity, film quality, and the like. The thickness of the reflective film is preferably 50 nm or more, more preferably 100 nm or more, in order to secure sufficient reflectivity.

First Gap Layer

The first gap layer is provided between the filter layer and the reflective film as required for smoothing the surface of the substrate. Furthermore, the first gap layer is effective to adjust the size of the hologram formed in the recording layer. Specifically, the gap layer between the recording layer and the servo pit pattern may be effective, since the recording layer requires the interference region of some larger size between the recording reference light and the informing light.

The first gap layer can be formed by, for example, applying UV curable resin etc. on the servo pit pattern by spin coating etc. and by curing the resin. In addition, when a filter layer is formed on a transparent base material, the transparent base material also serves as the first gap layer. The thickness of the first gap layer may be properly selected depending on the application; the thickness is preferably 1 to 200 μm.

Filter Layer

The filter layer is provided on the servo pit of the substrate, on the reflective layer, or on the first gap layer.

The filer layer performs wavelength-selective reflection in a manner that a light with a certain wavelength may be solely reflected among plural lights or beams. The filter layer may perform in particular to prevent diffuse reflection of the informing light and the reference light from the reflective film of the optical recording medium and to prevent noise generation without the sift of selective reflection wavelength even if the incident angle being altered; therefore, the lamination of the filter layer with the optical recording medium may achieve optical recording with excellently high resolution and diffraction efficiency.

The filter layer may be properly selected depending on the application; for example, the filter layer may be formed of a laminated body containing a dichroic mirror layer, a color material-containing layer, a dielectric vapor deposition layer, a cholesteric layer of mono layer or two or more layers, and other layers properly selected as required.

The filter layer may be laminated directly to the substrate by way of coating etc. along with the recording layer; alternatively, a filter for optical recording media is prepared by laminating on a base material such as films, then the filter for an optical recording medium may be laminated on the substrate.

Second Gap Layer

The second gap layer may be provided between the recording layer and the filter layer as required.

The material for the second gap layer may be properly selected depending on the application; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (product name, by JSR Corp.), ZEONOA (product, by Nippon Zeon). Among these, those with higher isotropy are preferable, and TAC, PC, ARTON and ZEONOA are most preferable.

The thickness of the second gap layer may be properly selected depending on the application; the thickness is preferably 1 μm to 200 μm.

The optical recording media according to the present invention will be explained more specifically with reference to figures.

### FIRST EMBODIMENT

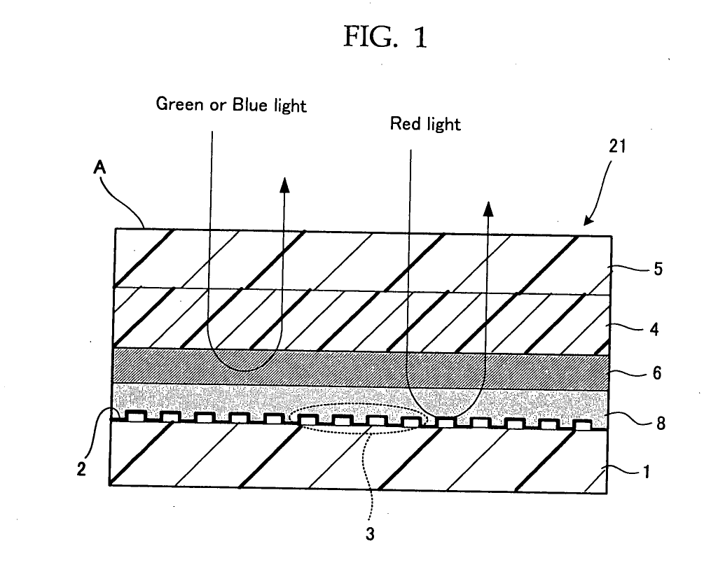

FIG. 1 is a schematic cross-sectional view showing the structure of the first embodiment of the optical recording medium in the present invention. In the optical recording medium 21 according to the first embodiment, servo pit pattern 3 is formed on the second substrate 1 made of a polycarbonate resin or glass, and the servo pit pattern 3 is coated with Al, Au, Pt or the like to form reflective film 2. Here, the servo pit pattern 3 is formed on the entire surface of the second substrate 1 in FIG. 1, it may be formed periodically. The height of the servo pit pattern 3 is usually 1750 angstroms (175 nm), which being significantly smaller than the other layers including the substrate.

The first gap layer 8 is formed by applying UV curable resin or the like on the reflective film 2 of the second substrate 1 by spin coating or the like. The first gap layer 8 is effective for protecting the reflective film 2 and for adjusting the size of holograms created in recording layer 4. Specifically, the interference region between the recording reference light and the informing light requires a level of size in the recording layer 4, a clearance is effectively provided between the recording layer 4 and the servo pit pattern 3.

The filter layer 6 is provided on the first gap layer 8, the second gap layer 7 is provided between the filter layer 6 and the first substrate 5 (polycarbonate resin or glass substrate), and the recording layer 4 is sandwiched to thereby constitute the optical recording medium 21.

In FIG. 1, the filter layer 6 transmits only red light and blocks the other color lights. Since the informing light, recording light and reproducing reference light are of green or blue, they do not pass through the filter layer 6 instead turn into a return light to emit from the entrance/exit surface A without reaching the reflective film 2.

The filter layer 6 is a multilayer vapor-deposited film consisting of alternatively laminated higher refractive-index layers and lower refractive-index layers. The filter layer 6 of the multilayer vapor-deposited film may be formed directly onto the first gap layer 8 by vacuum vapor deposition, alternatively may be disposed by punching through the multilayer vapor-deposited film formed on the substrate into the shape of the optical recording medium.

The optical recording medium 21 of this embodiment may be of disc shape or card shape. The servo pit pattern is unnecessary in the case of card shape. In the optical recording medium 21, the lower substrate 1 is 0.6 mm thick, the first gap layer 8 is 100 μm thick, the filter layer 6 is 2 μm to 3 μm thick, the recording layer 4 is 0.6 mm thick, and the upper substrate 5 is 0.6 mm thick, leading to the total thickness of about 1.9 mm.

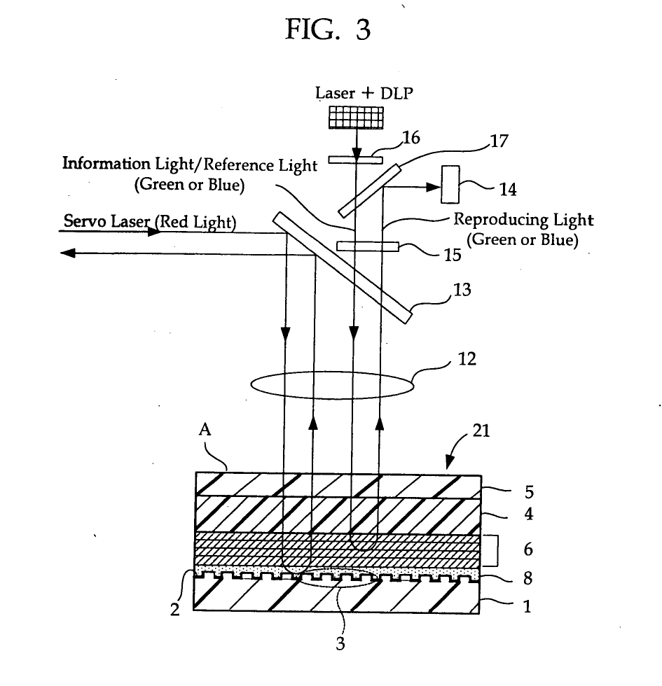

The optical operations around the optical recording medium 21 will be explained with reference to FIG. 3 in the following. Initially, red light emitted from the servo laser source is reflected by dichroic mirror 13 by almost 100%, and passes through objective lens 12. The servo light 10 is applied onto the optical recording medium 21 in such a way that it focuses on the reflective film 2. More specifically, the dichroic mirror 13 is configured to transmit only green or blue light but reflect almost 100% of red light. The servo light incident from the light entrance/exit surface A of the optical recording medium 21 passes through the upper substrate 5, recording layer 4, filter layer 6 and first gap layer 8, then is reflected by the reflective film 2, and passes again through the first gap layer 8, filter layer 6, recording layer 4 and upper substrate 5 to emit from the light entrance/exit surface A. The emitted return light passes through the objective lens 12 and is reflected by the dichroic mirror 13 by almost 100%, and then a servo information detector (not shown) detects servo information. The detected servo information is used for the focus servo operation, tracking servo operation, slide servo operation and the like. The hologram material constituting the recording layer 4 is designed so as to be insensitive to red light, therefore, even when the servo light passes through the recording layer 4 or reflects diffusively at the reflective film 2, the recording layer 4 is not adversely affected. In addition, the return servo light reflected by the reflective film 2 is reflected almost 100% by the dichroic mirror 13, accordingly, the servo light is non-detectable by CMOS sensor or CCD 14 used for the detection of reconstructed images, thus providing the diffracted light with no noise.

Both of the informing light and the recording reference light emitted from the recording/reproducing laser source pass through the polarizing plate 16 to form a linear polarization then to form a circular polarization after passing through the half mirror 17 and the quarter wave plate 15. The circular polarization then passes through the dichroic mirror 13, and illuminates the optical recording medium 21 by action of the objective lens 12 in a manner that the informing light and the reference light create an interference pattern in the recording layer 4. The informing light and reference light enter from the light entrance/exit surface A and interact with each other in the recording layer 4 to form and record an interference pattern. Thereafter, the informing light and reference light pass through the recording layer 4 and enter into the filter layer 6, and then, are reflected to turn into a return light before reaching the bottom of the filter layer 6. That is, the informing light and recording reference light do not reach the reflective film 2. This is because the filter layer 6, which being a multilayer vapor-deposited film consisting of alternatively laminated higher refractive-index layers and lower refractive-index layers, allows to exclusively transmit red light.

### Second Embodiment

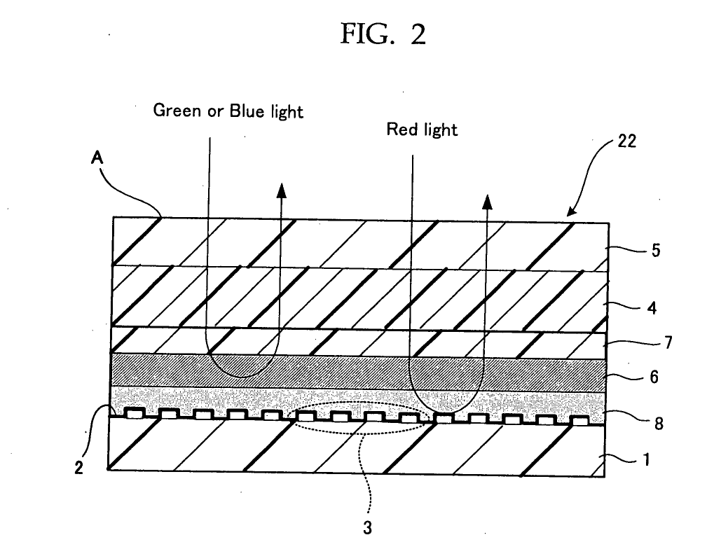

FIG. 2 is a schematic cross-sectional view showing the configuration of the second embodiment of the inventive optical recording medium. In the optical recording medium 22 of the second embodiment, servo pit pattern 3 is formed on the second substrate 1 made of polycarbonate resin or glass, and the servo pit pattern 3 is coated with Al, Au, Pt or the like to form the reflective film 2. The height of the servo pit pattern 3 is usually 1750 angstroms (175 nm), which being similar with the first embodiment.

The difference between the first embodiment and the second embodiment is that the second gap layer 7 is disposed between the filter layer 6 and the recording layer 4 in the optical recording medium 22 of the second embodiment. The second gap layer 7 involves a point at which the informing light and the reference light focus. Provided that this area is filled with a photopolymer, the monomer is likely to be excessively consumed by action of excessive exposure, resulting in decrease of multiple recording capacity. Accordingly, the nonreactive transparent second gap is effectively provided.

The filter layer 6 of a multilayer vapor-deposited film, consisting of alternatively laminated higher refractive-index layers and lower refractive-index layers, is formed on the first gap layer 8 after the first gap layer 8 being formed. The filter layer 6 may be similar as that of the first embodiment.

In the optical recording medium 22 of the second embodiment, the lower substrate 1 is 1.0 mm thick, the first gap layer 8 is 100 μm thick, the filter layer 6 is from 3 μm to 5 μm thick, the second gap layer 7 is 70 μm thick, the recording layer 4 is 0.6 mm thick, the upper substrate 5 is 0.4 mm thick, and the total thickness is about 2.2 mm.

Upon recording and reproducing information, the optical recording medium 22 having the structure described above is irradiated with a red servo light and a green informing light as well as a recording light and a reproducing reference light. The servo light enters from the light entrance/exit surface A, passes through the recording layer 4, the second gap layer 7, the filter layer 6, and the first gap layer 8, and is reflected by the reflective film 2 to turn into a return light. This return light sequentially passes through the first gap layer 8, the filter layer 6, the second gap layer 7, the recording layer 4 and upper substrate 5, and emits from the light entrance/exit surface A. The emitted return light is utilized for the focus servo operation, tracking servo operation and the like. The hologram material of the recording layer 4 is designed to be non-sensitive to red light; therefore, the recording layer 4 receives no influence even when the servo light has passed through the recording layer 4 or has been reflected diffusively by the reflective film 2. The green informing light etc. enter from the light entrance/exit surface A, then pass through the recording layer 4 and second gap layer 7, and are reflected by the filter layer 6 to turn into a return light. The return light sequentially passes through the second gap layer 7, the recording layer 4 and first substrate 5 again, and emits from the light entrance/exit surface A. Upon reproduction of information, both of the reproducing reference light and the diffracted light generated by irradiating the reproducing reference light onto the recording layer do not reach the reflective film 2 and emit from the light entrance/exit surface A. The optical operations around the optical recording medium 22 (i.e. the objective lens 12, filter layer 6, CMOS sensor or CCD 14 of detector in FIG. 3) are similar to those in the first embodiment, thus the description thereof will be omitted.

Optical Recording Method and Optical Reproducing Method

The optical recording method according to the present invention comprises irradiating an informing light and a reference light having a coherent property onto the optical recording medium according to the present invention, forming an interference image from the informing light and the reference light, and recording the interference image onto the recording layer of the optical recording medium.

In this method, the informing light and the reference light are irradiated onto the optical recording medium in a manner that the optical axis of the informing light is coaxial with the optical axis of the reference light, then the interference image generated by the interference between the informing light and the reference light is recorded onto the recording layer of the optical recording medium.

In the optical reproducing method according to the present invention, a reproducing light is irradiated onto the interference pattern of the recording layer which is recorded by the optical recording method according to the present invention.

In the optical recording method and the optical reproducing method according to the present invention, the informing light with a two-dimensional intensity distribution and the reference light with almost the same intensity to that of the informing light are superimposed inside the photosensitive recording layer, the resulting interference pattern formed inside the recording layer induces a distribution of the optical properties of the recording layer to thereby record such distribution as information. On the other hand, when the recorded information is to be read (reproduced), only the reference light (reproducing light) is irradiated onto the recording layer from the same direction to that irradiated at the time of recording, a light having a intensity distribution corresponding to the distribution of the optical property formed inside the recording layer is emitted from the recording layer as a diffracted light.

The optical recording method and the optical reproducing method according to the present invention may be carried out by use of the optical recording/reproducing apparatus explained below.

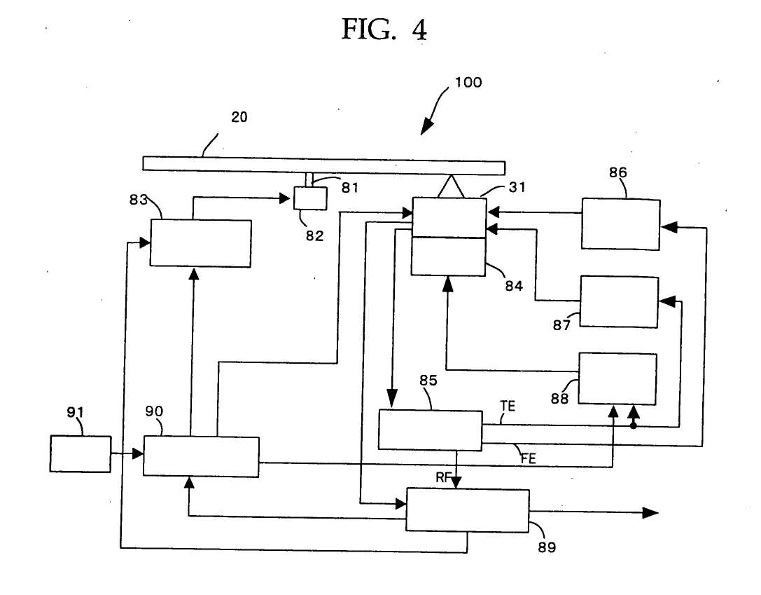

The optical recording/reproducing apparatuses applied to the optical recording method and the optical reproducing method according to the present invention will be explained with reference to FIG. 4.

This optical recording/reproducing apparatus 100 is equipped with spindle 81 on which the optical recording medium 20 is disposed, spindle motor 82 which rotates the spindle 81, and spindle servo circuit 83 which controls the spindle motor 82 so as to maintain the optical recording medium 20 at the predetermined revolution number.

The optical recording/reproducing apparatus 100 is also equipped with pickup unit 31 which irradiates the informing light and the reference light onto the optical recording medium so as to record information, and irradiates the reproducing reference light onto the optical recording medium 20 so as to detect the diffracted light to thereby reproduce the information recorded at the optical recording medium 20, and driving unit 84 which enables the pickup unit 31 to move in the radius direction of optical recording medium 20.

The optical recording/reproducing apparatus 100 is equipped with detecting circuit 85 which detects focusing error signal FE, tracking error signal TE, and reproducing signal RF from the output signal of the pickup unit 31, focusing servo circuit 86 which drives an actuator in the pickup unit 31 so as to move an objective lens (not shown) to the thickness direction of the optical recording medium 20 based upon the focusing error signal FE detected by the detecting circuit 85 to thereby perform focusing servo, a tracking servo circuit 87 which drives an actuator in the pickup unit 31 so as to move an objective lens (not shown) to the thickness direction of the optical recording medium 20 based upon the tracking error signal TE detected by the detecting circuit 85 to thereby perform tracking servo, and a sliding servo circuit 88 which controls the driving unit 84 based upon the tracking error signal TE and an indication from a controller mentioned hereinafter so as to move the pickup unit 31 to the radius direction of the optical recording medium 20 to thereby perform sliding servo.

The optical recording/reproducing apparatus 100 is also equipped with signal processing circuit 89 which decodes output data of the CMOS or CCD array described below in the pickup unit 31, to thereby reproduce the data recorded in the data area of the optical recording medium 21, and to reproduce the standard clock or to determine the address based on the reproducing signal RF from the detecting circuit 85, controller 90 which controls the whole optical recording/reproducing apparatus 100, and controlling unit 91 which gives various instructions to the controller 90. The controller 90 is configured to input the standard clock or address information outputted from the signal processing circuit 89 as well as controlling the pickup unit 31, the spindle servo circuit 83, the sliding servo circuit 88 and the like. The spindle servo circuit 83 is configured to input the standard clock outputted from the signal processing circuit 89. The controller 90 contains CPU (center processing unit), ROM (read only memory), and RAM (random access memory), the CPU realizes the function of the controller 90 by executing programs stored in the ROM on the RAM, a working area.

The optical recording/reproducing apparatuses, applied to the optical recording method and optical reproducing method according to the present invention, are equipped with the optical recording medium according to the present invention, thus can represent superior durability under recording heat and achieve high-density recording.

The present invention may solve various problems in the art, that is, may provide holographic recording compositions, which being adapted to digital volume holography with larger memory capacity, optical recording media, which containing the holographic recording compositions and performing optical-recording with super-high density, and also optical recording methods thereof.

The present invention will be explained with reference to examples, which are given for no more than illustration of the invention rather than for limiting its intended scope.

Synthesis 1

Synthesis of M-32

T-1 (synthetic product) expressed by the structural formula below was dissolved in an amount of 7.0 g into 300 mL of acetonitrile, to which then 1.8 g of triethylamine (by Tokyo Chemical Industry Co.) was added dropwise. After cooling the solution to 0° C., 1.66 g of acrylyl chloride (by Tokyo Chemical Industry Co.) was added dropwise. After mixing four hours, 500 mL of ethyl acetate and 500 mL of water were added to the mixture to extract an organic layer, then which was concentrated. The resulting material was treated with silica gel chromatography (hexane/ethyl acetate=1/1 of vol/vol), thereby to prepare the compound (M-32) expressed by the formula below in an amount of 6.0 g (yield: 75%). NMR data of the resulting compound M-32 is shown below.

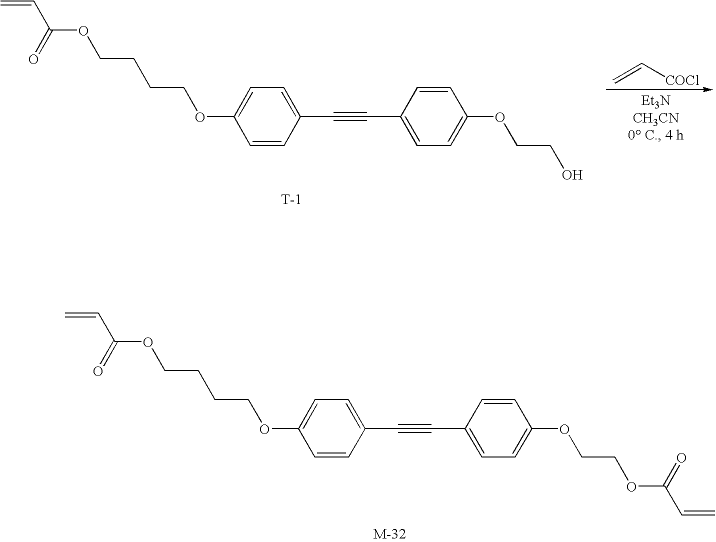

NMR data of M-32

¹H NMR (300 MHz, CDCl₃) δ1.89 (t, 4H), 3.98 (t, 2H), 4.24 (t, 4H). 4.62 (t, 2H), 5.85 (dd, 2H), 6.07˜6.22 (m, 2H), 6.43 (dd, 2H), 6.87 (t, 4H), 7.43 (dd, 4H)

Synthesis 2

Synthesis of M-33

T-2 (synthetic product) expressed by the structural formula below was dissolved in an amount of 2.1 g into 200 mL of N,N-dimethylacetamide (by Tokyo Chemical Industry Co.), to which then 2.8 g potassium carbonate (by Tokyo Chemical Industry Co.) was added. T-3 (synthetic product) expressed by the structural formula below was added in an amount of 5.8 g and the mixture was stirred at 90° C. for 4 hours, followed by adding 500 mL of ethyl acetate and 500 mL of water, then an organic layer was extracted and concentrated. The resulting material was treated with silica gel chromatography (hexane/ethyl acetate=1/1 of vol/vol), thereby to prepare the compound (M-33) expressed by the formula below. NMR data of the resulting compound M-33 is shown below.

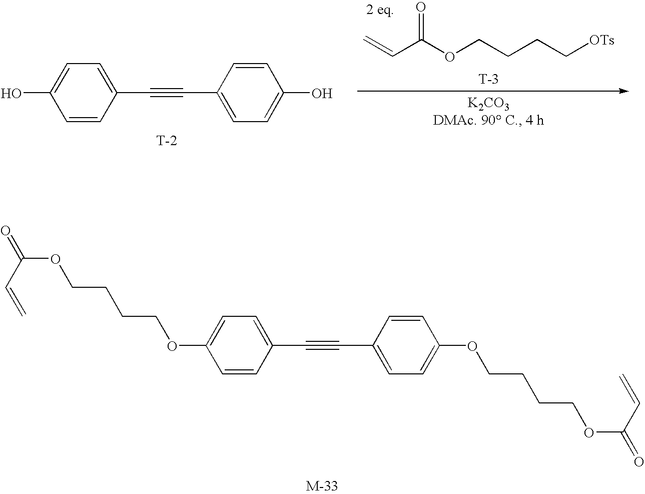

NMR data of M-33

¹H NMR (300 MHz, CDCl₃) δ1.83˜1.94 (brs, 8H). 4.02 (t, 4H), 4.27 (t, 4H), 5.83 (d, 2H), 6.14 (dd, 2H), 6.42 (d, 2H), 6.84 (d, 4H), 7.43 (d, 4H)

### EXAMPLE 1

Preparation of Holographic Recording Composition

A mixture consisting of 31.5 g of biscyclohexylmethane diisocyanate, 61.2 g of polypropyleneoxide triol (molecular weight: 1000), 2.5 g of tetramethylene glycol, 3.1 g of monomer M-3 expressed by the structural formula below, 0.69 g of a photopolymerization initiator (Irgacure 784, by Ciba Specialty Chemicals Co.) and 1.01 g of dibutyltin dilaurate was stirred under nitrogen gas atmosphere to prepare a holographic recording composition of Example 1.

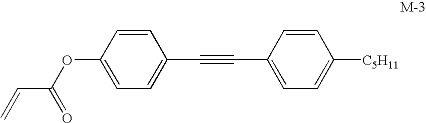

### EXAMPLE 2

Preparation of Holographic Recording Composition

A holographic recording composition of Example 2 was prepared in the same manner as Example 1 except for changing the monomer M-3 into the monomer M-1 expressed by the structural formula below.

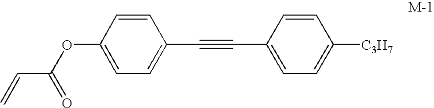

### EXAMPLE 3

Preparation of Holographic Recording Composition

A holographic recording composition of Example 3 was prepared in the same manner as Example 1 except for changing the monomer M-3 into the monomer M-22 expressed by the structural formula below.

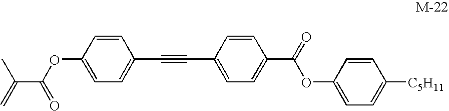

### EXAMPLE 4

Preparation of Holographic Recording Composition

A holographic recording composition of Example 4 was prepared in the same manner as Example 1 except for changing the monomer M-3 into the monomer M-32 expressed by the structural formula below.

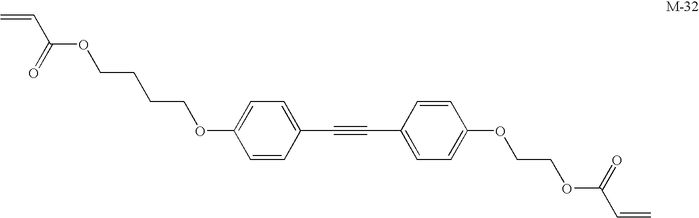

### EXAMPLE 5

Preparation of Holographic Recording Composition

A holographic recording composition of Example 5 was prepared in the same manner as Example 1 except for changing the monomer M-3 into the monomer M-33 expressed by the structural formula below.

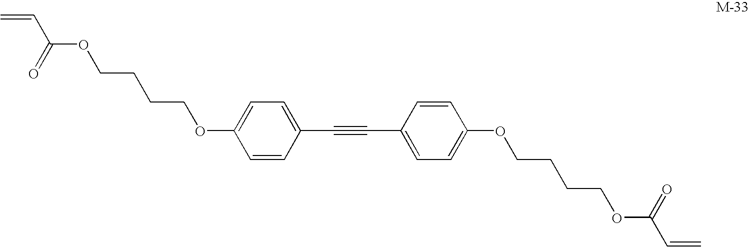

### EXAMPLE 6

Preparation of Holographic Recording Composition

A holographic recording composition of Example 6 was prepared in the same manner as Example 1 except for changing the monomer M-3 into the monomer M-34 expressed by the structural formula below.

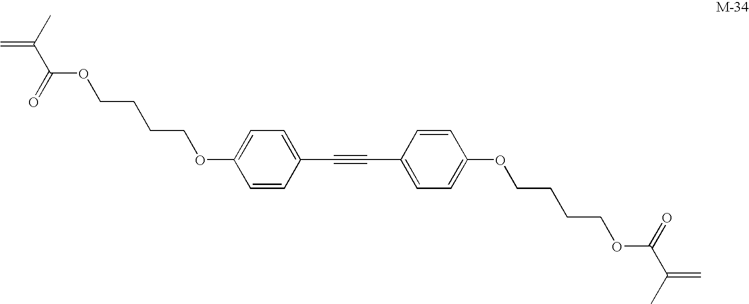

### EXAMPLE 7

Preparation of Holographic Recording Composition

A holographic recording composition of Example 7 was prepared in the same manner as Example 1 except for changing the monomer M-3 into the monomer M-35 expressed by the structural formula below.

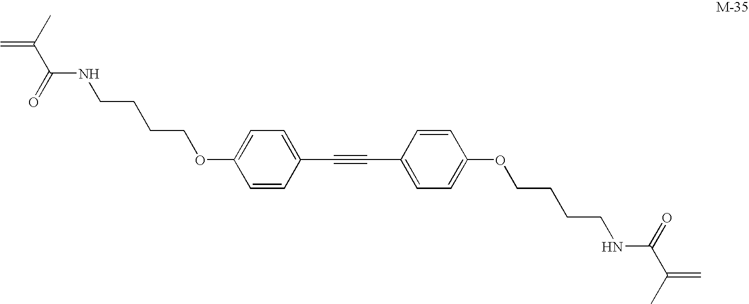

### COMPARATIVE EXAMPLE 1

Preparation of Holographic Recording Composition

A mixture consisting of 31.5 g of biscyclohexylmethane diisocyanate, 61.2 g of polypropyleneoxide triol (molecular weight: 1000), 2.5 g of tetramethylene glycol, 3.1 g of tribromophenyl acrylate, 0.69 g of a photopolymerization initiator (Irgacure 784, by Ciba Specialty Chemicals Co.) and 1.01 g of dibutyltin dilaurate was stirred under nitrogen gas atmosphere to prepare a holographic recording composition of Comparative Example 1.

### EXAMPLES 8 TO 14 AND COMPARATIVE EXAMPLE 2

Preparation of Optical Recording Medium

One surface of a glass sheet having a thickness of 0.5 mm was treated into to antireflection so as to give a reflectivity of 0.1% with respect to a normal incident having a wavelength of 532 nm, to thereby obtain a first substrate. Aluminum was vapor-deposited on one surface of another glass sheet having a thickness of 0.5 mm so as to give a reflectivity of 90% with respect to a normal incident light of wavelength 532 nm, to thereby obtain a second substrate.

Then, a spacer of transparent polyethylene terephthalate sheet of 500 μm thick was disposed on the surface of the first substrate which being not treated into antireflection, then the composition for hologram recording media was applied on the first substrate.

Then each of the holographic recording compositions obtained in Examples 1 to 7 and Comparative Example 1 was mounted on the first substrate, then the side of the second substrate, where the aluminum being deposited, was contacted to the side of the composition of the hologram recording media on the first substrate so as to trap no air therebetween, thereby the first substrate and the second substrate were laminated along with the spacer interposed therebetween. Finally, they were allowed to stand at 45° C. for 24 hours to prepare the respective optical recording media of Example 8 to 14 and Comparative Example 2.

Recording and Evaluation

By means of Collinear hologram recording/reproducing examiner SHOT-1000 (by Pulsetec Industrial Co.), the resulting optical recording media were respectively subjected to writing a series of multiplex holograms with a recording spot diameter of 200 μm at the focal point of the hologram recording. The recorded holograms were measured and evaluated in terms of sensitivity (recording energy) and multiplex index. The results are shown in Table 1.

Measurement of Sensitivity

The resulting optical recording media were measured for the variation of bit error rate (BER) of the reproduction signal while varying the irradiation light energy (mJ/cm²) at the recording. Generally speaking, as the irradiating optical energy is increased, the brightness of the reproduction signal increases and the BER of the reproduction signal tends to gradually decrease. In this case, the recording photosensitivity was determined with respect to the minimum irradiating optical energy which provided an approximately clear reproduced image (BER <10⁻³).

Evaluation of Multiplex Index

As a multiplex index evaluation for the optical recording medium, a method described in “ISOM'04, Th-J-06, pp. 184-185, October 2004” was applied. In this method, a recording spot was made shifted in a spiral direction to evaluate the multiplex index. Here, the number of the recorded hologram was set at 13×13=169 holograms, and the recording pitch was set at 28.5 μm. The multiplex index was 49 at the final (169th) hologram recording. As the number of the recorded holograms is increased, the multiplex index is increased; therefore, insufficient multiplicity results in increase of the BER as the recorded number increases. Accordingly, the number of the recording hologram volume at BER >10⁻³ was determined as the multiplex property M of the optical recording medium.

TABLE 1

| | Holographic | Recording | Multiplicity |
|---|---|---|---|
| | Recording | Sensitivity | Property |
| | Composition | (mJ/cm²) | M |
| Ex. 8 | Ex. 1 | 31 | 169 |
| Ex. 9 | Ex. 2 | 53 | 169 |
| Ex. 10 | Ex. 3 | 29 | 120 |
| Ex. 11 | Ex. 4 | 25 | 169 |
| Ex. 12 | Ex. 5 | 30 | 169 |
| Ex. 13 | Ex. 6 | 15 | 120 |
| Ex. 14 | Ex. 7 | 20 | 120 |
| Com. Ex. 2 | Com. Ex. 1 | 80 | 70 |

The results of Table 1 demonstrate that the optical recording media of Examples 8 to 14, formed from the holographic recording compositions of Examples 1 to 7, exhibit excellent recording sensitivity and proper multiplicity property compared to the holographic recording medium of Comparative Example 2 formed from the holographic recording composition of Comparative Example 1.

The holographic recording compositions according to the present invention may lead to higher-density recording, thus are appropriately utilized for various optical recording media of volume hologram type that can record images with higher density.

What is claimed is:

1. A holographic recording composition, comprising a monomer expressed by the Structural Formula (1) below: 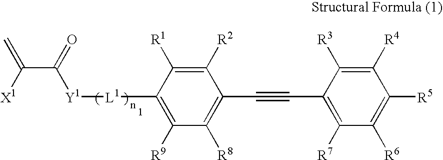
in the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group; n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom; 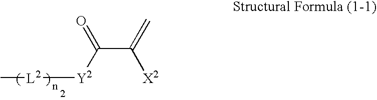
in the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

2. The holographic recording composition according to claim 1, wherein X¹ in the Structural Formula (1) is a hydrogen atom.

3. The holographic recording composition according to claim 1, wherein R¹ to R⁴ and R⁶ to R⁹ in the Structural Formula (1) are each a hydrogen atom, and R⁵ is an alkyl group that may have a substituent, an aryloxycarbonyl group, or a group expressed by the Structural Formula (1-1) described above.

4. The holographic recording composition according to claim 1, further comprising a matrix and a photopolymerization initiator.

5. The holographic recording composition according to claim 4, wherein the matrix is a urethane matrix formed from a polyfunctional isocyanate and a polyfunctional alcohol.

6. An optical recording medium, comprising a holographic recording layer,
wherein the holographic recording layer is formed from a holographic recording composition comprising a monomer expressed by the Structural Formula (1) below: 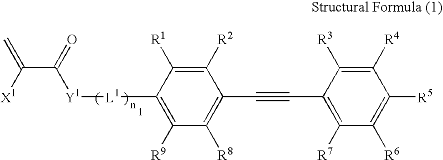
in the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group; n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom; 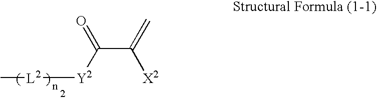
in the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.

7. The optical recording medium according to claim 6, comprising a first substrate, a filter layer, a holographic recording layer and a second substrate.

8. An optical recording method, comprising:
irradiating an informing light and a reference light, which being coherent each other, onto an optical recording medium,
forming an interference image from the informing light and the reference light, and
recording the interference image on a recording layer of the optical recording medium,
wherein the optical recording medium comprises a holographic recording layer, and the holographic recording layer is formed from a holographic recording composition comprising a monomer expressed by the Structural Formula (1) below: 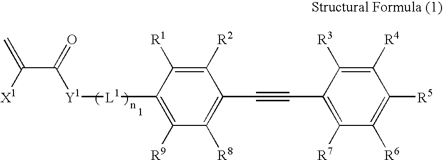
in the Structural Formula (1) shown above, X¹ represents a hydrogen atom or a methyl group; Y¹ represents an oxygen atom or NR¹⁰ (R¹⁰ represents a hydrogen atom or an alkyl group); L¹ represents a divalent organic connecting group; n₁ is an integer of 0 or 1; R¹ to R⁹ may be identical or different each other and each represents a hydrogen atom, halogen atom, alkyl group, aryl group, heterocyclic group, alkoxy group, aryloxy group, alkoxycarbonyl group, aryloxycarbonyl group, carbamoyl group, sulfamoyl group, amino group, acyloxy group, acylamino group, hydroxyl group, carbonic acid group, sulfonic acid group, or a group expressed by the Structural Formula (1-1) below; R¹ to R⁹ may be further substituted by a substituent; R¹ and R², R³ and R⁴, R⁴ and R⁵, R⁵ and R⁶, R⁶ and R⁷, or R⁸ and R⁹ may form a ring structure together with at least an adjacent carbon atom; 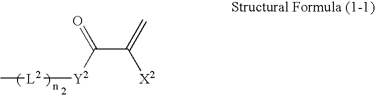
in the Structural Formula (1-1) shown above, X² represents a hydrogen atom or a methyl group; Y² represents an oxygen atom or NR¹⁰ (R¹⁰ represents a hydrogen atom or an alkyl group); L² represents a divalent organic connecting group, n₂ is an integer of 0 or 1.
